(19) United States
(12) Patent Application Publication
(10) Pub. No.: US 2012/0060404 A1
(43) Pub. Date: Mar. 15, 2012

(54) Screw-ball strike indicator

(76) Inventor: Michael J. Baron, Bishop, CA (US)

(21) Appl. No.: 12/807,724

(22) Filed: Sep. 14, 2010

(51) Int. Cl. A01K 93/02; A01K 93/00

(52) U.S. Cl. 43/44.92; 43/17; 43/44.87; 43/44.95

(57) ABSTRACT

A fly fishing device for indicating a strike from a fish which suspends a fly or lure a fixed distance above the bottom of a lake or river is disclosed. The device may include a strike indicator made from foam or other buoyant materials that includes a threaded set screw and O-Ring to attach the line/leader to the indicator body. Most strike indicators are either difficult to attach, or difficult to adjust. This invention will allow easy attachment, and easy adjustment.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. The Field of the Invention

The present disclosure relates generally to fishing devices and implements, and more particularly to strike indicators and devices for setting fish hooks, or signaling when a fish has taken the lure or fly.

2. Description of Related Art

In fly fishing a small, substantially weightless hooked lure which resembles a fly or other bug is cast into the water. Normally the lure is attached to a mono filament “line” or “leader” which is virtually transparent in the water. The line/leader is attached to a fly line, which is usually opaque. Flies can be classified into two main categories. Those that float on the surface referred to as “dry flies”, and those that sink, referred to as “wet flies”. The wet files include many patterns such as streamers, nymphs, soft hackles, and midges.

When a lure is cast into the water, a fish may attack the lure for a variety of reasons including instinct, anger, or hunger. During which time the angler has an opportunity to set the hook. If the lure floats unnaturally in the water, or, if the line or lure makes a big splash, the fish may be spooked and seek cover, thus refusing the fly. Assuming that the fish takes the fly, for the angler to hook the fish the fisherman must know that the fish has taken the fly. If the fisherman is using a fly that floats on the surface, the line, leader, and fly are all visible to the angler, making is easy to see that the fish has taken the fly.

Trout and many other fish, however, feed underwater nearly all of the time and are more likely to be taken on a fly that sinks close to, but not on the bottom. Knowing when a fish has taken a wet fly, nymph, or the like is traditionally done by feel and takes a great deal of training to perfect. When an underwater fly is used in fly fishing, the strike of a fish is very difficult to detect. Fly fisherman have been using strike indicators attached to the leaders of their fly lines to better detect when a fish takes their fly.

Typically, a fly is cast upstream and is fished back downstream to the fisherman. The fly typically moves naturally with the current downstream towards the fisherman. The fisherman often utilizes a floating strike indicator to help track the progress of the fly downstream. If a fish takes the fly, motion will be imparted on the strike indicator that is inconsistent with the current. For example, the strike indicator may be pulled underwater by the fish, or the strike indicator may move upstream instead of downstream, or it may move cross-current, etc. When the fisherman sees this unusual motion, the fisherman will attempt to quickly set the hook embedded in the fly by lifting the fly rod. The fisherman must react quickly, before the fish has time to get the fly out of it's mouth.

The strike indicators attempt to signal the moment that the fly has been eaten by the fish. The fisherman must maintain a balance between letting the fly float naturally with the current and keeping the line taught enough to deliver a quick hook set. The beginning fly fisherman will find this task very difficult, and experienced fly fisherman may never fully master this task.

Thus, strike indicators are known thought the fly fishing industry. There are a number of different kinds of strike indicators available. For example, a simple strike indicator know as a “stick-on” is comprised of a closed cell foam pad with a sticky backing. The angler peels one off of the sheet and wraps it around his line/leader at a certain depth. These will work well, but they can not be readjusted to fish another depth. They are a one time use indicator.

Another type of indicator is a small ball with a hole through the center, being in effect a small bobber. The leader is inserted through the hole and a toothpick or plastic post is wedged in the hole to keep the indicator in place. Once the toothpick or peg is inserted, it can not be moved to another depth. The toothpick or peg will also enlarge the hole in the indicator body thus causing the strike indicator to slide to an undesirable position.

An indicator can be made from a small tube of closed cell foam through which a heated wire is pushed. The leader is threaded through this hole, and a small piece of yarn is attached so that it protrudes from the top of the foam tube. When a fish pulls the foam tube under, the yarn alert makes the strike more noticeable. This indicator lands with a large splash, and is thereby disadvantageous.

Indicators can also be made of yarn treated with a silicon fly floatant. Sections of yarn are tied to the leader with the ends trimmed to keep the leader from twisting. This indicator is very light, but must be clipped off when one needs to change depths, thereby destroying the indicator.

An indicator can also have a small hole or grommet where the leader is pushed through the hole or grommet and looped over the body of the indicator. This version is easy to apply, but it has the tendency to slide to a different depth. When the indicator slides to a different position, it may bring the fly out of the strike zone for the area you are fishing.

It is noteworthy that none of the devices know to the applicant provides a lightweight, easy to apply, and easy to adjust strike indicator. There is a long felt, but currently unmet need for a strike indicator that meets all these needs.

The known devices are thus characterized by several disadvantages that are addressed by the present disclosure. The present disclosure minimizes, and in some aspects eliminates, the above mentioned failures, and other problems, by utilizing the features and methods described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF SUMMARY OF THE INVENTION

The embodiment of this new fly fishing strike indicator will solve all of the problems that exist with current strike indicators on the market today. It is extremely lightweight which will aid in casting, and minimize the splash that occurs when cast. It is extremely easy to affix to the line, and extremely easy to move to another position. In addition, there are no loose parts to lose, and no parts that will wear out, Because of the tension applied by the screw, this indicator will not move or slide to another position like other strike indicators, it stays right where the fisherman places it.

### BRIEF DESCRIPTION OF THE DRAWINGS

The features and advantages of the disclosure will become apparent from a consideration of the subsequent detailed description presented in connection with the accompanying drawings in which:

FIG. 1 is a side view of the 3 parts of this embodiment consisting of: 103—a small lightweight plastic or nylon set screw. 102—a small rubber or plastic O-Ring. 101—the indicator body made from a lightweight materiel.

FIG. 2 is a front view of the 3 parts of this embodiment consisting of: 103—a small lightweight plastic or nylon set screw. 102—a small rubber or plastic O-Ring. 101—the indicator body made from a lightweight materiel.

FIG. 3 and FIG. 4 are front views of the strike indicator illustrating the method of attaching the leader to the indicator body.

### DETAILED DESCRIPTION OF THE INVENTION

For the purpose of promoting an understanding of the principles in accordance with the disclosure, reference will now be made to the embodiments illustrated in the drawings and specific language will be used to describe the same. It will nevertheless be understood that no limitations of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the present structural features and methods are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present disclosure will be limited only by the appended claims and equivalents thereof.

In describing and claiming the present disclosure the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

Referring to FIG. 4 the present disclosure relates to a fishing device and more specifically to a light weight solid fly fishing strike indicator that attaches to the line/leader with a threaded screw and threaded insert.

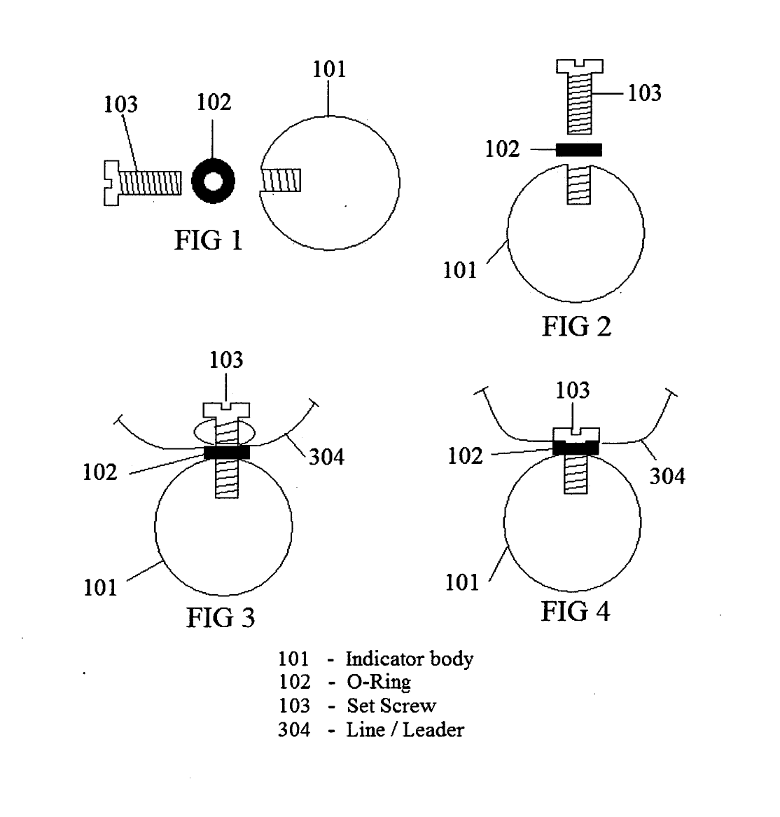

The body of the indicator, FIG. 1/101, is comprised of a solid round, oblong, or football shaped float usually being less than one inch in diameter. The indicator body can be made from cork, foam, polystyrene, plastic, or other similar material having a density less than that of water which will result in an indicator that floats on the surface of the water. The indicator should be as light as possible to avoid making a large splash when casting.

The indicator body, FIG. 1/101, will include a small hole with threads, or a small hole that is tight enough to provide a grip on a small threaded screw. The size of the hole should be the same as the diameter of the shaft of the screw excluding the thickness of the threads. The hole should be deep enough to allow the screw to be fully inserted into the body, or can extend completely through the entire body of the indicator thus allowing the screw to be inserted from either end. The hole can be made in the indicator body with a drill, a headed wire, or by having the hole molded into the indicator body as it is made.

Into the body of the indicator, a small threaded screw, FIG. 1/103, made from nylon, plastic, or other similar material will be used to affix the line/leader to the indicator body. The screw will be inserted into the small threaded hole, or, in the small hole without threads in the indicator body. The head of the screw may have a round, hex, square, or flat shape allowing the fisherman to both loosen and tighten the screw. The screw may contain a standard Slot, Phillips, or Thumbscrew head used to assist the fisherman in both loosening and tightening the screw.

Over the shaft of the screw a small rubber, plastic, nylon, or other similar material O-Ring, FIG. 1/102, may be used to keep the line/leader away from the threaded portions of the indicator body. The O-Ring may be optional if the body of the indicator is made from a material that is soft enough so that it will not damage the line/leader.

To use this new fly fishing strike indicator, FIGS. 3 and 4, the fisherman will first loosen the set screw a few turns to allow enough space for the line/leader. The next step is to wrap the line/leader around the shaft of the screw. The final step is to tighten the screw until the line/leader is firmly set at the desired position. When the fisherman is ready to move the indicator to a new position, just loosen the set screw, remove the line/leader. Place the indicator at the new position and tighten the set screw.

In the past, fly fishing strike indicators have used 5 main methods to attach the indicator to the line/leader. First, some indicators use knots to attach the indicator to the line/leader. Knots have the problem of creating a weak spot in the line/leader, and are usually permanent and unmovable. Second, many indicators use loops in the line/leader around the body of the indicator for attachment. This method usually does not weaken the line/leader, but it is still difficult to move the indicator, and they will usually slide to another position after repeated casting. Third, a hard peg made from wood or plastic is wedged into a hole in the indicator body along with the line/leader. This method is easy to move to another position, but because the line is pinched between the peg and the indicator body, it will also weaken the line. The fourth method is to use a soft rubber peg that is laid along the line, the peg and line are twisted and wedged into a slot in the indicator body. This method is easy to adjust, does not weaken the line, but the peg will loosen after several casts and fall off. Once this happens, the indicator is useless. The final method is to use an small foam indicator with a sticky back. The indicator is folded on the line/leader and will stay where it is applied. The problem is that this is a one time use only, it can not be removed and reused.

This new fly fishing strike indicator uses a small set screw and O-Ring to affix the indicator to the line/leader. There are no knots to weaken the line/leader, there are no wooden or plastic pegs that wear holes in an indicator body, and there are no soft rubber pegs to loosen. This new fly fishing strike indicator will stay exactly where the fisherman places it, can be moved to another position in seconds. And, there are no loose parts that can be lost or misplaced.

Those having ordinary skill in the relevant art will appreciate the advantages provided by the features of the present disclosure. For example, it is a potential feature of the present disclosure to provide a fly fishing strike indicator that is simple in design, simple to affix to the line, simple to re-adjust, and simple to manufacture.

What is claimed is:

1. A fishing device used to suspend a fly or lure at a certain depth above the bottom of a lake or river; wherein the device is used to signal when a fish takes the attached fly or lure, and is comprised of:
(a) a lighter than water body with a hole used to accept a threaded screw,
(b) a plastic or nylon set screw used to attach the line/leader to the indicator body,
(c) a small rubber or plastic O-Ring used to keep the line/leader away from the threaded portion of the indicator.
